(19) United States
(12) Patent Application Publication
(10) Pub. No.: US 2006/0137432 A1
(43) Pub. Date: Jun. 29, 2006

(54) Process for collecting and concentrating trace organics in a liquid sample

(75) Inventors: Kon-Tsu Kin, Hsinchu (TW); Shu-Fei Chan, Hsinchu (TW); Chiou-Mei Chen, Hsinchu (TW); Chang-Ming Lin, Hsinchu (TW)

Correspondence Address: BIRCH STEWART KOLASCH & BIRCH, PO BOX 747, FALLS CHURCH, VA, 22040-0747, US

(73) Assignee: INDUSTRIAL TECHNOLOGY RESEARCH INSTITUE

(21) Appl. No.: 11/217,354

(22) Filed: Sep. 2, 2005

(30) Foreign Application Priority Data
Dec. 29, 2004 (TW) 93141250

(51) Int. Cl. G01N 11/00

(52) U.S. Cl. 73/53.01

(57) ABSTRACT

The present invention discloses a process for collecting and concentrating trace organics in a liquid sample, which includes steps of adsorption, dehydration, and thermal desorption. The process can be automatically operated by associating with analysis instruments for detecting gaseous materials, such as GC (Gas Chromatography), GC-MS (Gas Chromatography-Mass spectroscopy) and FTIR (Fourier Transfer Infrared spectroscopy) to monitor the organics in the liquid sample. The process can collect and concentrate semi-volatile organic contaminants in a liquid sample which are unable to be collected and concentrated by purge & trap process or head-space process. The process of the present invention can be used to detect trace organics in a detecting limit at a ppt level. The present invention renders other advantages of being able to be on-line operated with analysis instruments, minimizing the manual operation errors, free from organic solvent contamination, rapid detecting time, high detection accuracy, and high detection sensitivity.

### FIELD OF THE INVENTION

The present invention relates to a process for collecting and concentrating trace organics in a liquid sample, particularly to a process for collecting and concentrating trace organics in a liquid sample, which can be operated in association with analysis instruments.

### BACKGROUND OF THE INVENTION

To analyze organic contaminants in an aqueous sample or a liquid sample containing complex matrix, the step of sampling and concentrating the organic contaminants is an important key step. The ideal procedure of sampling and concentrating the organic contaminants should be operated automatically by using a simple device but without using organic solvents, and the adsorbent could be recycled for next use.

Currently, the technique for trapping organic contaminants is mainly classified into eight (8) methods. Among them, excluding a liquid-liquid phase extraction (LLE) which is seldom used recently, there are three (3) methods suitable for trapping organic contaminants in a liquid sample as follows. (1) Solid-phase extraction (SPE) which includes the steps of adsorbing organic contaminants in a liquid sample on solid adsorbent, eluting the adsorbent with solvents, concentrating the eluted fraction to a desired volume, and analyzing the concentrate. This method has disadvantages of using solvent as an eluent, procedure complexity, occurrence of second contamination and manual operation errors, and requiring long detection time. (2) Solid phase micro extraction (SPME) which includes the steps of coating few adsorbent on a detecting needle to trap organic contaminants in a liquid sample, and introducing the trapped contaminants into analysis instruments by thermal desorption. This method has advantages of simple procedures and without using solvent but also has a disadvantage of trapping trace amount of contaminants which are difficult to attain the analysis in ppt level. (3) Purge and Trap method which includes the steps of purging nitrogen or helium gas into a liquid sample to blow out volatile organic contaminants from the liquid sample, trapping the organic contaminants by adsorbent-filled micro-trap to concentrate the contaminants, rapidly heating the trap to desorb the contaminants, and introducing the desorbed contaminants into analysis instruments via carrier gas to detect. The Purge and Trap method could be designed to be operated automatically and is particularly suitable for detecting volatile organic. Its detecting limit would attain a ppt level depending on the organic species to be tested. However, this Purge and Trap method is not suitable for detecting semi-volatile organic and high polar organic and could not attain a ppt to ppb detecting level in this regard.

### SUMMARY OF THE INVENTION

The main object of the present invention is to provide a process for collecting and concentrating trace organics in a liquid sample which possesses no disadvantages found in the prior art.

Accordingly, the present invention relates to a process for collecting and concentrating trace organics in a liquid sample, which comprises the following steps:

(a) continuously passing a liquid sample through a adsorbent-filled tube to adsorb the organic contained in the liquid sample on the adsorbent;

(b) stopping passing the liquid sample through the tube;

(c) continuously blowing hydrogen gas or an inert gas into the tube to carry the liquid component out from the tube and keep the organic adsorbing on the adsorbent; and

(d) stopping blowing the hydrogen gas or the inert gas into the tube.

Preferably, the process of the present invention further comprises the steps of:

(e) rapidly heating the tube while passing a carrier gas continuously through the adsorbent-filled tube and a cold trap in sequence, thereby the organic adsorbed on the adsorbent is desorbed and carried out from the tube by the carrier gas, and the desorbed organics is further condensed and collected in the coldtrap; and

(f) stopping passing the carrier gas through the column.

Preferably, the process of the present invention further comprises the steps of:

(g) rapidly heating the coldtrap while passing a carrier gas continuously through the coldtrap and an analysis instrument in sequence, thereby the organic condensed and collected in the coldtrap is carried into the analysis instrument by the carrier gas; and

(h) stopping passing the carrier gas through the coldtrap.

Preferably, the liquid sample in the step (a) is an aqueous sample and the liquid in the step (c) is water, and the adsorbent used in the step (a) is hydrophobic adsorbent made in polymer or carbon based material which is thermal stable at a temperature of more than 270° C.

Preferably, the inert gas used in the step (c) is nitrogen gas, helium gas, or a mixture thereof.

Preferably, in the step (e), the tube is heated at a heating rate of more than 40° C./sec.

Preferably, the inert gas used in the step (e) is nitrogen gas, helium gas, or a mixture thereof.

Preferably, the coldtrap in the step (e) further includes a micro-tube which is filled with trace amount of hydrophobic adsorbent or glass beads maintained at a temperature of from −30° C. to 150° C.

Preferably, in the step (g), the coldtrap is heated at a heating rate of more than 40° C./sec.

Preferably, the inert gas used in the step (g) is nitrogen gas, helium gas, or a mixture thereof.

Preferably, in the process for collecting and concentrating trace organics in a liquid sample according to the present invention, the transportation of the liquid sample, the inert gas, hydrogen gas, and the carrier gas is by using a line made from the material not releasing any organic material nor adsorbing organic to avoid the contamination of organics to be collected and prevent from influencing detecting sensitivity.

The analysis instruments used in the present invention includes analysis instruments for detecting gaseous materials such as GC (Gas Chromatography), GC-MS (Gas Chromatography-Mass spectroscopy) and FTIR (Fourier Transform Infrared spectroscopy).

### BRIEF DESCRIPTION OF THE DRAWINGS

FIG. 1 is a flow chart showing an organic trapping procedure in one preferred embodiment of the process for collecting and concentrating trace organics in a liquid sample according to the present invention;

FIG. 2 is a flow chart showing a dehydration procedure in the preferred embodiment of the process for collecting and concentrating trace organics in a liquid sample according to the present invention;

FIG. 3 is a flow chart showing the first thermal desorption procedure in the preferred embodiment of the process for collecting and concentrating trace organics in a liquid sample according to the present invention;

FIG. 4 is a flow chart showing the second thermal desorption procedure in the preferred embodiment of the process for collecting and concentrating trace organics in a liquid sample according to the present invention; and

FIG. 5 shows a gas chromatography spectrum of the organic trapped in the Example of the present invention.

### DETAILED DESCRIPTION OF THE PRESENT INVENTION

The differences between the process for collecting and concentrating trace organics in a liquid sample according to the present invention with the prior art processes are summarized in Table. The major difference of the present process with the prior art process is that, in the present process, the liquid sample is directly passed through a adsorbent-filled tube to adsorb and concentrate the organics, and dehydration, then the adsorbed organic is desorbed by heating and then the desorbed organic is introduced into analysis instrument. But in the prior art process, the organic desorption is carried by using solvent extraction and then the desorbed organic is injected manually or introduced directly into analysis instrument. In other words, the present process takes the advantages of large adsorbed amount in the SPE (Solid Phase Extraction) process, adsorption-desorption manner in the SPME (Solid Phase Micro Extraction) process, and dehydration procedure in the Purge and Trap process but eliminate the disadvantages found in these processes.

TABLE 1
The differences between the present process with the
prior art processes

| | The present | | SPME | Purge & Trap |
|---|---|---|---|---|
| | invention | SPE Process | Process | Process |
| The manner of | Liquid sample | Liquid sample | A sampling | Inert gas is |
| Extraction & | is directly | is directly | needle | introduced into |
| Concentration | introduced into | introduced into | coated with | liquid sample to |
| | adsorbent-filled | adsorbent-filled | adsorbent is | blow organic out |
| | tubeto collect | tubeto collect | immersed | and then collect |
| | and concentrate | and concentrate | in the | and concentrate |
| | organics | organics | liquid | the organics in an |
| | | | sample or | adsorbent-filled |
| | | | placed in | micro-trap |
| | | | head space | |
| | | | above the | |
| | | | liquid | |
| | | | sample to | |
| | | | collect and | |
| | | | concentrate | |
| | | | organics | |
| The manner | Thermal | Extracting the | Thermal | Thermal |
| for | desoroption | organics from | desorption | desoroption (the |
| introducing | (the adsorbent- | the tubeby | | adsorbent-filled |
| into analysis | filled tube | using solvent | | micro-trapshould |
| instrument | should be | and inject the | | be dehydrated in |
| | dehydrated in | organic into | | advance) |
| | advance) | analysis | | |
| | | instrument | | |
| Monitor on- | Yes | Yes | Yes | Yes |
| line | | | | |
| Secondary | No | Yes | No | No |
| solvent | | | | |
| contamination | | | | |
| Detection | ppt level | ppt-ppb level | ppb-ppm | ppt-ppb level |
| limit | | | level | |
| Organic | Volatiles, semi- | Volatiles and | Volatiles, | Volatile organics |
| species | volatiles, polar | semi-volatile | semi- | |
| capable to be | organics | organics | volatiles, | |
| detected | | | polar | |
| | | | organics | |
| Advantages | Easily operate, | Large | Easily | Easily operate, |
| | detecting limit | adsorbing | operate, | the used analysis |
| | of ppt level, no | amount and | rapid and | instrument has |
| | solvent | thus can | time- | been available in |
| | contamination, | process large | saving, no | market, suited for |
| | suitable in wide | amount of | solvent | volatile organic |
| | variety organic | sample each | contamination | |
| | species | time | | |
| disadvantages | | Complex | Higher | Poor effect for |
| | | procedures, | detection | semi-volatile |
| | | easily result in | limit, not | organics |
| | | solvent | suitablefor | |
| | | contamination | ultra-pure | |
| | | | water/ | |
| | | | ultra-pure | |
| | | | liquid | |
| | | | analysis | |

The process for collecting and concentrating trace organics in a liquid sample according to the present invention is a process combining an adsorption, dehydration, and thermal-desorption steps. One preferred embodiment of the process for collecting and concentrating trace organics in a liquid sample according to the present invention will be illustrated in more detail by reference to the accompanying drawings.

The process for collecting and concentrating trace organics in a liquid sample according to the present invention mainly comprises three steps as follows.

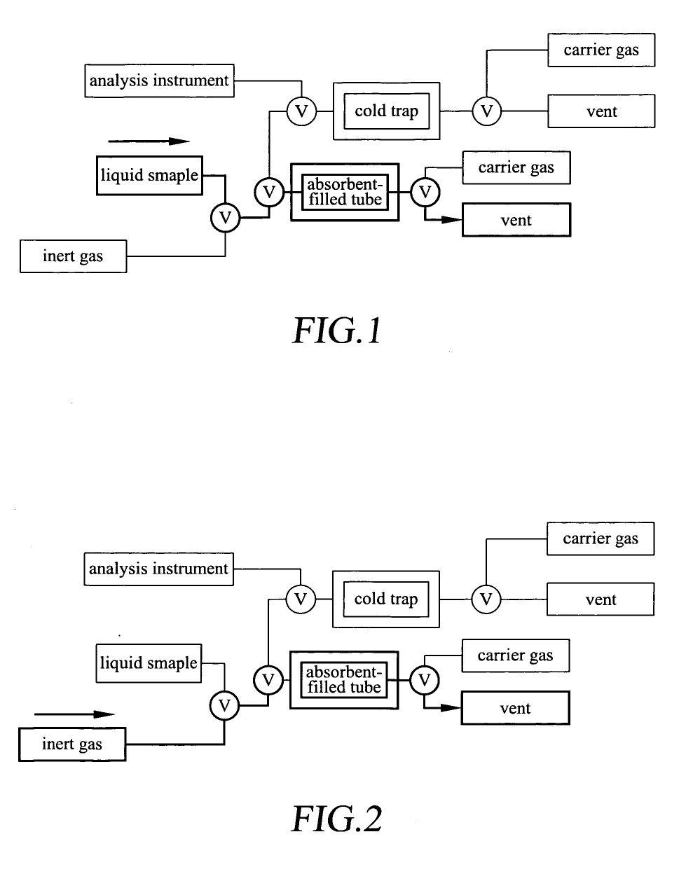

Please refer to FIG. 1. FIG. 1 is a flow chart showing an organic trapping procedure in the present process. A liquid sample is passed through an adsorbent-filled tube by using peristaltic pump or the like to collect and concentrate the organics in the liquid sample in the tube. The liquid sample in which the organic has been trapped in the tube is discharged through an exhausting port. The lines connecting each member should be made from a material which would not release any organics material nor adsorb any organic, such as made from perfluoroalkoxy fluorocarbon (PFA), to avoid detection error.

Next please refer to FIG. 2. FIG. 2 is a flow chart showing a dehydration procedure in the present process. A dehydrated inert gas is introduced into the tube to remove residual liquid remained in the adsorbent and the inert gas is then discharged via the exhausting port. The adsorbent filled in the tube should be a hydrophobic adsorbent which withstands a temperature of more than 270° C. and possesses a property of adsorbing organic effectively. The adsorbent could be filled in either a single bed or multiple beds.

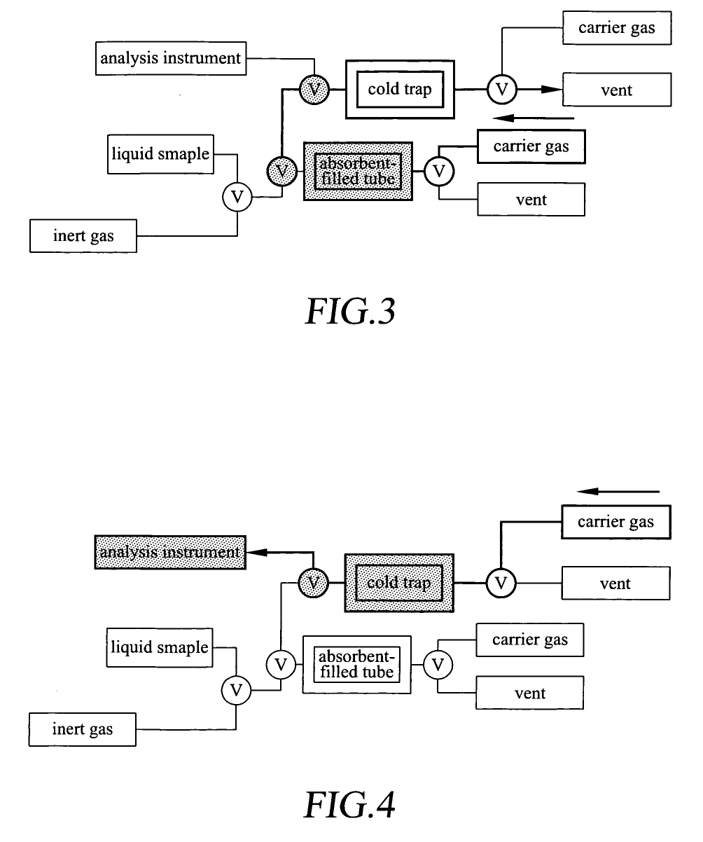

Please refer to FIG. 3. FIG. 3 is a flow chart showing the first thermal desorption procedure in the present process. The tube is heated suddenly to a predetermined temperature and a carrier gas is passed through the tube in a direction opposite to the sampling direction to desorb the organics. Subsequently, the desorbed organics is introduced into a coldtrap filled with trace amount of hydrophobic adsorbent or glass beads maintained at a temperature of from −30° C. to 150° C. In the coldtrap, the organics is subjected to a secondary adsorption to further increase the analysis resolution and detecting sensitivity.

Please refer to FIG. 4. FIG. 4 is a flow chart showing the second thermal desorption procedure in the present process. The coldtrap is heated suddenly to a predetermined temperature and a carrier gas is passed through the trap in a direction opposite to the sampling direction to desorb and introduce the organics into analysis instruments for detecting.

The process for collecting and concentrating trace organics in a liquid sample according to the present invention possesses the advantages of handling a large amount of liquid in one time as found in SPE method, of easily operation and no use of toxic solvent as found in SPME method. According to the present process, the organic contained in liquid sample to be tested could be introduced into analysis instruments in a whole amount and thus a detecting limit can be increased to a ppt level.

### EXAMPLE 1

### Detection of a Liquid Sample Containing Organic by Manual Operation

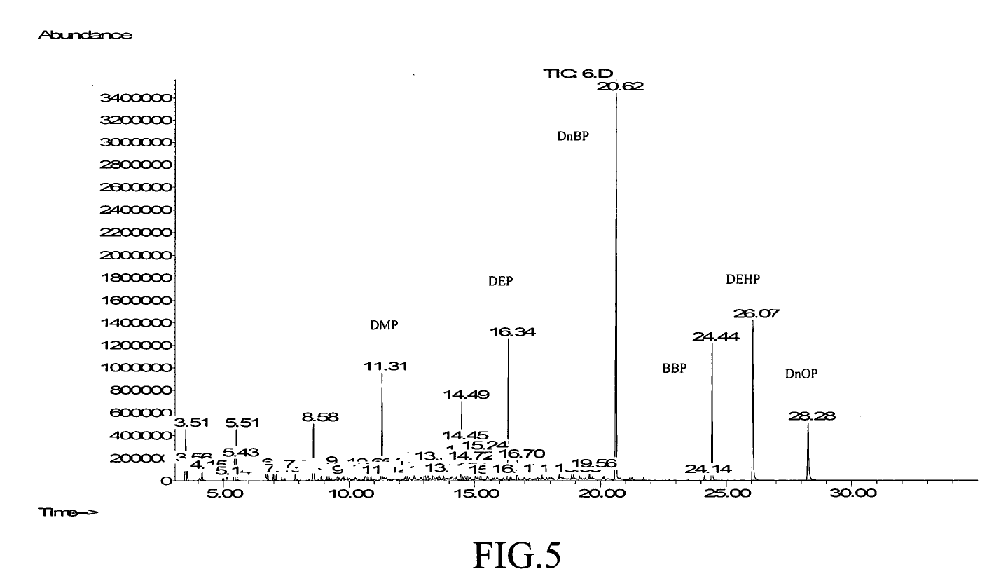

In this example, one liter of a standard liquid sample containing dimethyl phthalate (DMP), diethyl phthalate (DEP), di-n-butyl phthalate (DnBP), diethyl hexyl phthalate (DEHP),butylbenzyl phthalate(BBP), amd di-n-octylphthalate(DnOP) each in an amount of 200 ppt was passed into a tube filled with about 200 mg of adsorbent at a flow rate of 5 to 200 mL/min by using a peristaltic pump via a PFA made lines. The adsorbent filled in the tube was a hydrophobic polymeric resin withstood a temperature of more than 300° C., which can be commercial available. Then, hydrogen gas or an inert gas such as nitrogen or helium gas or a mixture thereof as a carrier gas was introduced into the tube at a flow rate of 10 to 2000 mL/min to remove residual water from the adsorbent. Subsequently, the tube was connected to an ATD-GC-MS(Perkin-Elmer TurboMatrix, Agilent 6890 GC, Agilent 5973N MS) to subject to detection. The analysis results are shown in FIG. 5. From FIG. 5, it is known that the adsorbent could effectively adsorb the six kinds of phthalate, i.e. DMP, DEP, DnBP, BBP, DEHP and DnOP. Also, residual water remained in the adsorbent was removed effectively and thus would not influence the analysis results.

The adsorbent filled tube could be selected from a variety of adsorbent depending on the organics species in the sample to be tested.

What is claimed is:

1. A process for collecting and concentrating trace organics in a liquid sample, which comprises the following steps:
(a) continuously passing a liquid sample through a adsorbent-filled tube to adsorb the organics in the liquid sample on the adsorbent;
(b) stopping passing the liquid sample through the column;
(c) continuously blowing hydrogen gas or an inert gas into the tube to carry the liquid component out from the tube and keep the organic adsorbing on the adsorbent; and
(d) stopping blowing the hydrogen gas or the inert gas into the tube.

2. The process according to claim 1, which further comprises the steps of:
(e) rapidly heating the tube while passing a carrier gas continuously through the adsorbent-filled tube and a coldtrap in sequence, thereby the organic adsorbed on the adsorbent is desorbed out from the tube by the carrier gas, and the desorbed organics is further condensed and collected in the coldtrap; and
(f) stopping passing the carrier gas through the tube.

3. The process according to claim 2, which further comprises the steps of:
(g) rapidly heating the coldtrap while passing a carrier gas continuously through the coldtrap and an analysis instrument in sequence, thereby the organic condensed and collected in the coldtrap is desorbed into the analysis instrument by the carrier gas; and
(h) stopping passing the carrier gas through the coldtrap.

4. The process according to claim 1, wherein the liquid sample in the step (a) is an aqueous sample and the liquid in the step (c) is a water, and the adsorbent used in the step (a) is hydrophobic adsorbent which is thermal stable at a temperature of more than 270° C.

5. The process according to claim 1, wherein the inert gas used in the step (c) is nitrogen gas, helium gas, or a mixture thereof.

6. The process according to claim 2, wherein in the step (e), the tube is heated at a heating rate of more than 40° C./sec.

7. The process according to claim 2, wherein the inert gas used in the step (e) is nitrogen gas, helium gas, or a mixture thereof.

8. The process according to claim 3, wherein the coldtrap in the step (e) further includes a micro-tube which is filled with trace amount of hydrophobic adsorbent or glass beads maintained at a temperature of from −30° C. to 150° C.

9. The process according to claim 3, wherein in the step (g), the coldtrap is heated at a heating rate of more than 40° C./sec.

10. The process according to claim 3, wherein the inert gas used in the step (g) is nitrogen gas, helium gas, or a mixture thereof.

11. The process according to any one claim of claims 1-3, wherein the transportation of the liquid sample, the inert gas, hydrogen gas, and the carrier gas is by using a line made from the material not releasing or adsorbing organics.
